(19) United States
(12) Patent Application Publication
(10) Pub. No.: US 2016/0264418 A1
(43) Pub. Date: Sep. 15, 2016

(54) APPARATUS AND METHOD FOR COMPRESSING AND/OR COOLING AND PURIFYING A CARBON DIOXIDE RICH GAS CONTAINER WATER

(71) Applicant: L'Air Liquide, Societe Anonyme pour l'Etude et l'Exploitation des Procedes Georges Claude, Paris (FR)

(72) Inventors: Mathieu LECLERC, Paris (FR); Christophe SZAMLEWSKI, Combs La Ville (FR)

(73) Assignee: L'Air Liquide, Societe Anonyme pour l'Etude et l'Exploitation des Procedes Georges Claude, Paris (FR)

(21) Appl. No.: 15/034,101

(22) PCT Filed: Nov. 6, 2014
(86) PCT No.: PCT/FR2014/052827

§ 371 Date: May 3, 2016

(30) Foreign Application Priority Data
Nov. 8, 2013 (FR) 1360931

(51) Int. Cl. C01B 3/50; B01D 53/04; C01B 3/34; B01D 53/26

(52) U.S. Cl. CPC C01B 3/506; B01D 53/265; B01D 53/261; B01D 53/0446; C01B 3/34; B01D 2256/22; B01D 2256/16; B01D 2256/10; B01D 2256/20; B01D 2256/245; B01D 2257/80; B01D 2259/40086; C01B 2203/0255; C01B 2203/0495; C01B 2203/042

(57) ABSTRACT

The invention relates to an apparatus for compressing and/or cooling and purifying a feed gas that is rich in CO₂ and contains water and impurities and at least one other component, wherein said apparatus includes a compressor and/or a cooler, means for delivering the feed gas into the compressor, means for recovering the water, contained in the feed gas, condensed during the compression, a unit for purification by adsorption containing adsorbent beds, means for delivering the compressed feed gas to the purification unit in order to produce a compressed and dried feed gas, a unit for purification at sub-ambient temperature, means for delivering the compressed and dried feed gas to the purification unit, means for extracting a fluid enriched with CO₂ from the purification unit and means for mixing a gas that has been used as a regeneration gas of an adsorption bed with at least one portion of the condensed water.

### CROSS REFERENCE TO RELATED APPLICATIONS

This application is a §371 of International PCT Application PCT/FR2014/052827, filed Nov. 6, 2014, which claims the benefit of FR1360931, filed Nov. 8, 2013, both of which are herein incorporated by reference in their entireties.

### TECHNICAL FIELD OF THE INVENTION

The present invention relates to an apparatus and a method for compressing and/or cooling and purifying a carbon dioxide-rich gas containing water.

More specifically, embodiments of the invention relate to:
an apparatus and a method for compressing and/or cooling and purifying a carbon dioxide-rich gas containing water, and
an apparatus and a method for compressing and purifying a carbon dioxide-rich gas containing water, and
an apparatus and a method for cooling and purifying a carbon dioxide-rich gas containing water.

A carbon dioxide-rich gas contains at least 30% carbon dioxide. All the percentages in this document relating to purities are molar percentages.

In particular, certain embodiments of the invention relate to a method for vaporizing condensates produced during the compression and/or cooling of a carbon dioxide-rich gas. The gas can be then purified at sub-ambient temperature.

The feed gas to be compressed and/or cooled and to be purified may originate from a unit for producing hydrogen and/or carbon monoxide.

At least one portion of the vapor generated by the vaporization of the condensates is sent to the burners of a unit for producing hydrogen and/or carbon monoxide.

### BACKGROUND OF THE INVENTION

Units for producing hydrogen (H₂) and/or carbon monoxide (CO) by steam reforming of hydrocarbons and/or by partial oxidation also coproduce large amounts of carbon dioxide (CO₂). This CO₂ essentially results from the conversion of CO and steam into CO₂ and H₂. It is therefore possible to use a sub-ambient temperature purification unit (CPU) for capturing CO₂ to purify it, compress it and export it in order especially to use it for EOR (enhanced oil recovery) or for sequestering CO₂.

In the case of SMR (steam methane reforming) it is possible for example to choose to install the CPU after the H₂ PSA unit, thereby treating the particularly CO₂-laden waste gas thereof. A CPU may also be used on units for partial oxidation (PDX) of light hydrocarbons or units for autothermal reforming (ATR).

A unit for purifying CO₂ at sub-ambient temperature (referred to as a “CPU”) comprises at least a step of compressing the treated gas, a step of drying and at least one step at sub-ambient temperature in which the CO₂ is separated from the other compounds.

The step at sub-ambient temperature may be a partial condensation or distillation or washing.

The compression step generates condensates containing essentially water, and CO₂ dissolved in the water, but also impurities resulting from parasitic reactions taking place in the unit for producing H₂ and/or CO. The impurities present in the highest amounts are above all methanol, ammonia and amines. These impurities frequently require complex treatments.

In FR-A-2999555, a solution is proposed for integrating these condensates with the condensates from the plant for producing H₂ and/or CO in which the CO₂ is captured. However, this solution may not be possible in some cases, especially in cases of modification of an existing apparatus in which the existing equipment for treating condensates does not always make it possible to treat the additional stream from the CPU. Moreover, the equipment which makes it possible to treat these condensates is very often operated at very high pressures (of the order of 50 bara), whereas the condensates from the CPU will be at a much lower pressure: between 1 and 50 bara for those resulting from compression and between 1 and 5 bara for those resulting from the regeneration phase of the dryer. Thus, it is necessary to pressurize the condensates by pumping them to bring them to the pressure of the equipment. The dryer of the CPU will preferentially be regenerated with a residual fluid which is hardly affected by the presence of water resulting from the desorption of the water contained in the adsorbent cylinders. To optimize this regeneration, a low-pressure fluid is used. In this context, waste from the CPU after expansion (since it was sent to the burners of the unit for producing H₂ and/or CO) is recommended. However, condensates may be generated during the regeneration phase, especially as it is often sought to stabilize the temperature of the gas from the cylinder during regeneration by cooling it. These condensates will therefore be at the regeneration pressure.

### SUMMARY OF THE INVENTION

Certain embodiments of the invention make it possible especially to avoid the use of a pump to remove the condensates from the compressor by treating the condensates in a novel manner.

According to one subject of the invention, an apparatus is provided for compressing and/or cooling and purifying a carbon dioxide-rich feed gas containing water and impurities and at least one of the following components: hydrogen, carbon monoxide, methane and nitrogen, comprising: a compressor and/or a cooler, means for delivering the feed gas to the compressor and/or to the cooler, means for recovering water present in the feed gas and condensed during the compression in the compressor and/or the cooling in the feed gas cooler, a unit for scrubbing by adsorption containing adsorbent beds, means for delivering the compressed and optionally cooled feed gas to the scrubbing unit to produce a compressed and dried feed gas, a sub-ambient temperature purification unit, means for delivering the compressed and optionally cooled and dried feed gas to the purification unit, means for extracting a carbon dioxide-enriched fluid from the purification unit, means for delivering a regeneration gas to the scrubbing unit, means for extracting the water-enriched regeneration gas from an adsorption bed of the scrubbing unit and means for mixing at least a portion of the water condensed during the compression and/or cooling with the water-enriched regeneration gas to form a wet gas stream.

According to other optional subjects, the apparatus may include:
means for heating the water-enriched regeneration gas, preferably upstream of the point at which the fluid is mixed with water condensed during the compression.
a liquid diffuser to mix the condensed water with the water-enriched regeneration gas.
means for taking off a carbon dioxide-depleted gas from the purification unit and for delivering it to the scrubbing unit as regeneration gas.

According to another subject of the invention, an apparatus for producing a synthesis gas and a carbon dioxide-enriched gas is provided, comprising a unit for generating synthesis gas, a unit for enriching the synthesis gas in CO₂ to produce a feed gas, an apparatus for compressing and/or cooling and purifying as claimed in one of the preceding claims, means for delivering the feed gas to the compression and purification apparatus to be compressed and purified therein, and means for delivering at least a portion of the wet gas stream to the unit for generating synthesis gas.

According to another subject of the invention, a method is provided for compressing and/or cooling and purifying a carbon dioxide-rich feed gas containing water and impurities and at least one of the following components: hydrogen, carbon monoxide, methane and nitrogen, wherein the feed gas is compressed and/or cooled, the water condensed during the compression and/or cooling is recovered, the compressed and/or cooled feed gas is delivered to a scrubbing unit to be dried, the dried feed gas from the scrubbing unit is delivered, the dried gas is cooled to a sub-ambient temperature and purified to form a carbon dioxide-enriched fluid and a carbon dioxide-depleted fluid, a regeneration gas, optionally composed of at least a portion of the carbon dioxide-depleted fluid, is delivered to the scrubbing unit as regeneration gas, the gas which served as regeneration gas is mixed with at least a portion of the water condensed during the compression and/or cooling, to form a wet gas stream.

According to other optional aspects:
the carbon dioxide-rich feed gas contains at least 30%, or even at least 60%, carbon dioxide;
the feed gas contains hydrogen, preferably at least 10%, or even at least 30%, hydrogen;
the feed gas contains methane, preferably at least 10%, or even at least 30%, methane;
the feed gas contains carbon monoxide;
the regeneration gas at the outlet of the scrubbing unit contains at least 50%, or even at least 75%, methane;
the regeneration gas at the outlet of the scrubbing unit contains at least 3%, or even at least 5%, hydrogen;
the carbon dioxide-rich feed gas contains hydrogen and methane;
the carbon dioxide-rich feed gas contains hydrogen and methane and carbon monoxide;
the gas, optionally the carbon dioxide-depleted fluid, which served as regeneration gas is reheated in order to substantially vaporize all the water that it contains;
the gas, optionally the carbon dioxide-depleted fluid, which served as regeneration gas is reheated in order to substantially vaporize all the condensed water which is subsequently mixed with the fluid;
the gas which served as regeneration gas is reheated to a temperature of between 80° C. and 200° C.;
the condensed water is at a higher pressure than the gas which served as regeneration gas.

According to another subject of the invention, a method for producing a synthesis gas and a carbon dioxide-enriched gas is provided, wherein a synthesis gas is generated in a unit for generating synthesis gas, the synthesis gas is enriched in CO₂ to produce a feed gas, the feed gas is compressed and/or cooled and is purified as described above, and at least a portion of the wet gas stream is delivered to the unit for generating synthesis gas.

The synthesis gas may be generated by a method comprising a step of fuel combustion. In this case, the wet gas stream is optionally delivered to the combustion step.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

The FIGURE represents a process flow diagram in accordance with an embodiment of the present invention.

### DETAILED DESCRIPTION

The wet gas which is treated in the CPU is conventionally used as fuel and delivered to the burners when there is no CO₂ capture. The water which it contains is therefore conventionally delivered to the burners of a unit for producing synthesis gas. The invention may include vaporizing the condensates and delivering them, with the waste gas which served for regenerating the dryer, for example to the burners. To this end, the use of a reheater can preferably be chosen instead of a cooling exchanger situated over the waste gas which served for regenerating the dryer. Thus, the gas intended to be burnt will be preheated and it will be ensured that there is no liquid water remaining in this gas. In this way, condensate pumps are no longer necessary.

More specifically, the waste gas will be reheated after regeneration by means of a steam reheater, by means of an electric reheater or by means of a reheater using a heat source at a sufficiently high temperature to vaporize the liquid water from the dryer and to superheat the gas to beyond its dew point. This superheating is carried out for several reasons:
firstly, it makes it possible to avoid condensation of the water in the pipe which passes from this reheater to the burners (since the condensates are corrosive, pipes made of carbon steel may be retained if sufficient superheating is carried out to avoid their formation);
secondly, this superheating makes it possible to have enough energy available to vaporize the other condensates by direct contact, those condensates resulting from the compression of the wet flue gases at the inlet. Thus, a liquid diffuser will be used in the pipe for the gas superheated to a high temperature, with the droplets leaving the diffuser being vaporized. It is therefore unnecessary to use a dedicated vaporizer for these condensates.

The temperature at the outlet of the reheater will be between 80° C. and 200° C. and the temperature after vaporization at the outlet of the diffuser will therefore be between 60° C. and 180° C.

The invention will be described in more detail with reference to the FIGURE which shows a method according to the invention.

A synthesis gas 1 is generated in a unit G for generating synthesis gases by reforming. The unit G comprises a combustion chamber fed by a fuel F. The synthesis gas 1 undergoes a reaction and/or a separation in a unit S to increase its CO₂ content to form a feed gas 3. This feed gas 3, containing at least 35% carbon dioxide and water, is delivered to a compressor C1 where it is compressed to a pressure of 10 bar. This has the effect of causing a portion of the water that it contains to condense. Alternatively, the water may be condensed by cooling the feed gas, compressing it or not compressing it. This water H is recovered in a pipeline, optionally connected to a cooler R downstream of the compressor.

The word “water” covers any liquid composed predominantly of water. The water may for example contain carbonic acid, dissolved methanol, dissolved amines or dissolved ammonia.

It will be appreciated that if the gas is already at the correct pressure, the compression step is unnecessary and simple cooling will suffice to condense the water present in the gas.

The partially dried gas 7 is delivered to a scrubbing unit E comprising at least two adsorbent beds E1 and E2. The gas is scrubbed of water in the first bed E1 by adsorption and then is optionally recompressed in another compressor to 50 bar then delivered to a purification unit CPU in which it is cooled and separated at sub-ambient temperature in at least one phase separator and/or in a distillation column and/or in a washing column.

The purification unit CPU produces a carbon dioxide-enriched liquid or gas 10 containing at least 95% carbon dioxide. The unit also produces a dry, CO₂-depleted waste gas 11. This waste gas 11 serves as regeneration gas for the scrubbing unit E and is delivered to the adsorbent bed E2 where it becomes laden with water to produce a wet gas. Scrubbing is carried out in a cycle in a known way and for a portion of the cycle the gas 7 is dried in the bed E1 and for the other portion in the bed E2. This enables the gas 11 to regenerate the bed E2 while the bed E1 absorbs moisture, and to regenerate the bed E1 while the bed E2 absorbs moisture.

The composition of the wet gas 13 is:

| Component | Content (vol %) |
|---|---|
| H₂O | 2.1 |
| CO₂ | 4.6 |
| N₂ | 2.2 |
| CO | 4.3 |
| H₂ | 5.6 |
| CH₄ | 81.2 |

The wet gas 13 exiting the bed E2 (or E1 when the bed E2 is in an adsorption phase) at a pressure of between 1 and 3 bar is reheated by means of a steam reheater, by means of an electric reheater or by means of a reheater using a heat source at a sufficiently high temperature to vaporize the liquid water (if there is any) from the scrubbing unit and to superheat the gas to beyond its dew point. The temperature of the reheated gas 15 at the outlet of the reheater W will be between 80° C. and 200° C.

Downstream of the reheater W, the pipes for transporting the gas 15 which served for regeneration are made of carbon steel.

Next, the gas 15 which served for regeneration at between 80° C. and 200° C. is mixed with the condensed water H produced by the compression of the feed gas 3. The condensed water H at 10 bar is introduced into the gas pipeline 15 which served for regeneration by means of a liquid diffuser D. The condensed water is at a higher pressure than the regeneration gas 15, therefore no pipe is required to mix the two fluids. As the gas is already superheated to a high temperature, the water droplets exiting the diffuser D are vaporized. It is therefore unnecessary to use a dedicated vaporizer for these condensates.

The temperature of the gas 19 after vaporization at the outlet of the diffuser will therefore be between 60° C. and 180° C.

The wet gas 19 formed by mixing the condensed water H and the gas 15 which served for regeneration is delivered to the combustion chamber of the unit for generating synthesis gas. It may be delivered independently (stream 21) or mixed with the fuel F (stream 21A).

In this example, the regeneration gas 11 originates solely from the purification unit CPU. However, it is possible for the regeneration gas to come from another source.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-14. (canceled)

15. An apparatus for compressing and/or cooling and purifying a carbon dioxide-rich feed gas containing water and impurities and at least one of the following components: hydrogen, carbon monoxide, methane and nitrogen, the apparatus comprising:
a first device selected from the group consisting of a compressor, a cooler and combinations thereof;
means for delivering the feed gas to the first device;
means for recovering water present in the feed gas and condensed within the first device to form a partially dried gas;
a scrubbing unit configured to scrub the partially dried gas by adsorption, wherein the scrubbing unit includes adsorption beds, wherein the scrubbing unit is in fluid communication with the first device such that the scrubbing unit is configured to receive the partially dried gas downstream the first device under conditions effective for scrubbing the partially dried gas to produce a dried feed gas, wherein the scrubbing unit is configured to be regenerated using a regeneration gas thereby producing a water-enriched regeneration gas;
a sub-ambient temperature purification unit in fluid communication with the scrubbing unit such that the sub-ambient temperature purification unit is configured to receive the dried feed gas downstream the scrubbing unit and produce a carbon dioxide-enriched fluid and a waste gas, wherein the waste gas is depleted in carbon dioxide as compared to the dried feed gas;
means for extracting the carbon dioxide-enriched fluid from the purification unit;
means for delivering the regeneration gas to the scrubbing unit, wherein the regeneration gas comprises the waste gas;
means for extracting the water-enriched regeneration gas from one of the adsorption beds of the scrubbing unit; and
means for mixing at least a portion of the water condensed within the first device with the water-enriched regeneration gas to form a wet gas stream.

16. The apparatus as claimed in claim 15, comprising means for heating the water-enriched regeneration gas upstream of the point at which the water-enriched regeneration gas is mixed with the water condensed within the first device.

17. The apparatus as claimed in claim 15, comprising a liquid diffuser to mix the condensed water with the water-enriched regeneration gas.

18. The apparatus as claimed in claim 15, comprising means for removing a carbon dioxide-depleted gas from the purification unit and for delivering the carbon dioxide-depleted gas to the scrubbing unit as regeneration gas.

19. The apparatus as claimed in claim 15, wherein the means for delivering the feed gas to the first device comprises a unit for generating synthesis gas; a unit for enriching the synthesis gas in CO₂ to produce the feed gas, and the apparatus further comprises means for delivering at least a portion of the wet gas stream to the unit for generating synthesis gas.

20. A method for compressing and/or cooling and purifying a carbon dioxide-rich feed gas containing water and impurities and at least one of the following components: hydrogen, carbon monoxide, methane and nitrogen, the method comprising the steps of:
providing the carbon dioxide-rich feed gas;
condensing water within the carbon dioxide-rich feed gas using a first device to produce liquid water and a partially dried gas, wherein the first device is selected from the group consisting of a compressor, a cooler and combinations thereof;
recovering the liquid water condensed within the first device;
drying the partially dried gas recovered downstream the first device in a scrubbing unit to produce a dried feed gas;
cooling and purifying the dried feed gas to a sub-ambient temperature to form a carbon dioxide-enriched fluid and a carbon dioxide-depleted fluid;
regenerating the scrubbing unit using a regeneration gas, thereby forming a water-enriched regeneration gas; and
mixing the water-enriched regeneration gas and the liquid water condensed within the first device to form a wet gas stream.

21. The method as claimed in claim 20, further comprising the step of reheating the water-enriched regeneration gas in order to substantially vaporize all the liquid water within the regeneration gas.

22. The method as claimed in claim 21, wherein the step of reheating the water-enriched regeneration gas occurs prior to the step of mixing the water-enriched regeneration gas and the liquid water.

23. The method as claimed in claim Error! Reference source not found, wherein the water-enriched regeneration gas is reheated to a temperature of between 80° C. and 200° C.

24. The method as claimed in claim 20, wherein the liquid water from the first device is at a higher pressure than the water-enriched regeneration gas.

25. The method as claimed in claim 20, wherein the water-enriched regeneration gas is reheated to a temperature of between 80° C. and 200° C.

26. The method as claimed in claim 20, wherein the step of mixing the water-enriched regeneration gas and the liquid water from the first device using a liquid diffuser.

27. The method as claimed in claim 20, wherein the step of providing the carbon dioxide-rich feed gas further comprises the steps of generating a synthesis gas in a syngas unit; enriching the synthesis gas CO₂ to produce the carbon dioxide-rich feed gas, wherein the method further comprises the step of delivering at least a portion of the wet gas stream to the syngas unit.

28. The method as claimed in claim 27, wherein the synthesis gas is generated by a method comprising a step of fuel combustion and wherein the wet gas stream is delivered to the combustion step.

29. The method as claimed in claim 28, wherein the wet gas is mixed with the fuel delivered to the combustion.

30. The method as claimed in claim 20, wherein the regeneration gas comprises the carbon dioxide-depleted fluid.
